(19) United States
(12) Patent Application Publication
(10) Pub. No.: US 2006/0120103 A1
(43) Pub. Date: Jun. 8, 2006

(54) Liquid-crystal display apparatus and backlight module thereof

(75) Inventor: Feng-Li Lin, Taipei County (TW)

Correspondence Address: BIRCH STEWART KOLASCH & BIRCH, PO BOX 747, FALLS CHURCH, VA, 22040-0747, US

(73) Assignee: GIGNO TECHNOLOGY CO., LTD.

(21) Appl. No.: 11/265,148

(22) Filed: Nov. 3, 2005

(30) Foreign Application Priority Data
Dec. 3, 2004 (TW) 093137525

(51) Int. Cl. A47F 3/00; G01D 11/28

(52) U.S. Cl. 362/561; 362/560; 362/559; 362/330

(57) ABSTRACT

A backlight module includes at least one light-emitting unit, a power-signal generating circuit board and a control circuit board. The light-emitting unit at least has an electrode pin. The power-signal generating circuit board at least generates a power signal for driving the light-emitting unit. The electrode pin of the light-emitting unit directly connects to the power-signal generating circuit board. The control circuit board electrically connects to the power-signal generating circuit board and at least generates a switching signal. The power-signal generating circuit board generates the power signal according to the switching signal.

### BACKGROUND OF THE INVENTION

1. Field of Invention

The invention relates to a flat display apparatus and a backlight module thereof and, in particular, to a liquid-crystal display apparatus and a backlight module thereof.

2. Related Art

In general, the liquid-crystal display apparatus mainly includes a liquid-crystal display unit and a backlight module. At present, two types of the backlight module are usually adopted: the direct-type backlight module and side-edge backlight module.

Recently, the liquid-crystal display apparatus is widely spread and the related technology is well developed. Moreover, the size of the display apparatus, especially used as a TV, is becoming larger. The most popular size for LCD TV is about 27 inch to 42 inch. Considering the ever-growing size of liquid-crystal display apparatus, the direct-type backlight module, which has more light-emitting units than that of the side-edge backlight module to provide adequate brightness, is more commonly used.

Both the aforementioned backlight modules need at least one driving circuit board to drive the light-emitting units of the backlight modules. At present, the manufacturer usually utilizes cold cathode fluorescent lamps (CCFL) as the light-emitting units, and uses the driving circuit board to provide a driving signal with a high voltage for driving the light-emitting units. As shown in FIG. 1, in order to facilitate connecting and assembling the light-emitting unit 11 (CCFL) and the driving circuit board 13, the manufacturer may install a connecting wire 12, which is high voltage durable and includes a connecting terminal 121, to electrically connect to the electrode terminals 111 and 112 of the light-emitting unit 11. The connecting terminal 121 then connects to a connecting terminal 131 of the driving circuit board 13. In such a case, the high-voltage driving signal outputted by the driving circuit board 13 can be transmitted to and drive the light-emitting unit 11 through the connecting terminal 131, the connecting terminal 121 and the connecting wire 12.

In the above-mentioned backlight module, the driving signal provided by the driving circuit board 13 is commonly at the kilovolt level. Therefore, if the connecting terminal 131 of the driving circuit board 13 and the connecting terminal 121 of the connecting wire 12 do not properly connect to each other or are in poor contact, the arcing phenomenon always occurs and may even cause disasters. Moreover, to connect the light-emitting unit 11 to the driving circuit board 13 with the connecting wire 12, labor work is inevitable. In other words, the manufacturing process cannot be automatic. Besides, the connecting wire 12 and the connecting terminals 121 and 131 must be high voltage durable, so that the material cost is higher. In addition, since the signal passing through the connecting wire 12 is a kilovolt-level high-voltage signal working at as high frequency as KHz, the current leakage phenomenon may occur along the connecting wire 12 due to the coupling effect from the space stray capacitance. As a result, the current for driving the light-emitting unit may not be easily controlled.

It is therefore an important subject of the invention to provide a liquid-crystal display apparatus and a backlight module thereof, which can enable automation for reducing the manufacturing cost and can prevent the arcing phenomenon and the current leakage phenomenon.

### SUMMARY OF THE INVENTION

In view of the foregoing, the invention is to provide a liquid-crystal display apparatus and a backlight module thereof, which can prevent the arcing phenomenon and the current leakage phenomenon and can enable the automation of the manufacturing process.

To achieve the above, a backlight module of the invention includes at least one light-emitting unit, a power-signal generating circuit board, and a control circuit board. In the invention, the light-emitting unit at least has an electrode pin. The power-signal generating circuit board at least generates a power signal for driving the light-emitting unit. The electrode pin of the light-emitting unit directly connects to the power-signal generating circuit board. The control circuit board electrically connects to the power-signal generating circuit board and at least generates a switching signal. The power-signal generating circuit board generates the power signal according to the switching signal.

As mentioned above, the light-emitting unit of the backlight module directly connects to the power-signal generating circuit board. In other words, the high-voltage driving signal provided by the power-signal generating circuit board is directly inputted into the light-emitting unit. Besides, the electrical transmission signal between the power-signal generating circuit board and the control circuit board belongs to the lower voltage level. Thus, the arcing phenomenon caused by the high voltage can be prevented. Furthermore, since the light-emitting unit directly connects to the power-signal generating circuit board, the conventional connecting wire is unnecessary. That is, the assembling process of the light-emitting unit and the power-signal generating circuit board can be performed by utilizing an automatic machine and without any labor work. Moreover, the light-emitting unit and the power-signal generating circuit board are directly connected, so that the high-voltage durable connecting wire and connecting terminals are unnecessary. In other words, the cost for the expensive high-voltage durable connecting wire and connecting terminals can be saved, and, of course, the current leakage phenomenon can be prevented.

In addition, the invention also discloses a liquid-crystal display apparatus, which includes a backlight module. The backlight module includes at least one light-emitting unit, a power-signal generating circuit board, and a control circuit board. In the invention, the light-emitting unit at least has an electrode pin. The power-signal generating circuit board at least generates a power signal for driving the light-emitting unit. The electrode pin of the light-emitting unit directly connects to the power-signal generating circuit board. The control circuit board electrically connects to the power-signal generating circuit board and at least generates a switching signal. The power-signal generating circuit board generates the power signal according to the switching signal.

As mentioned above, in the backlight module of the liquid-crystal display apparatus of the invention, the light-emitting unit directly connects to the power-signal generating circuit board. In other words, the high-voltage driving signal provided by the power-signal generating circuit board is directly inputted into the light-emitting unit. Besides, the electrical transmission signal between the power-signal generating circuit board and the control circuit board belongs to the lower voltage level. Thus, the arcing phenomenon caused by the high voltage can be prevented. Furthermore, since the light-emitting unit directly connects to the power-signal generating circuit board, the conventional connecting wire is unnecessary. That is, the assembling process of the light-emitting unit and the power-signal generating circuit board can be performed by utilizing an automatic machine without any labor work. Moreover, the light-emitting unit and the power-signal generating circuit board are directly connected to each other, so that the high-voltage durable connecting wire and connecting terminals are unnecessary. In other words, the cost for the expensive high-voltage durable connecting wire and connecting terminals can be saved, and, of course, the electric leakage phenomenon can be prevented.

### BRIEF DESCRIPTION OF THE DRAWINGS

The invention will become more fully understood from the detailed description given herein below illustration only, and thus is not limitative of the present invention, and wherein:

FIG. 1 is a schematic diagram showing the major components of the conventional backlight module;

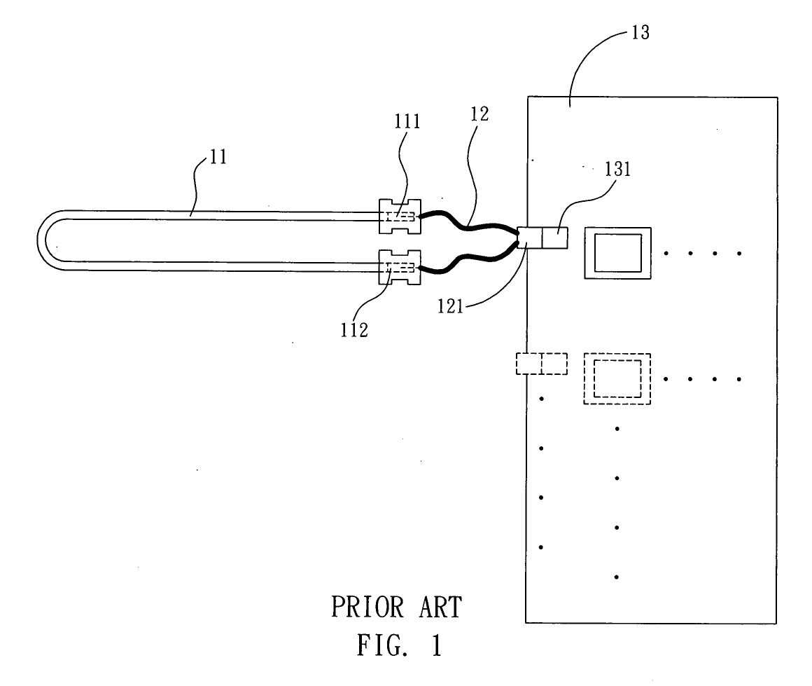

FIG. 2 is a schematic diagram showing the major components of a backlight module according to a preferred embodiment of the invention;

FIG. 3 is another schematic diagram showing the major components of the backlight module according to the preferred embodiment of the invention, wherein a circuit surface of the power-signal generating circuit board is perpendicular to a reflecting surface of the case;

FIG. 4 is still another schematic diagram showing the major components of the backlight module according to the preferred embodiment of the invention, wherein two power-signal generating circuit boards are respectively disposed at two sides of the light-emitting unit;

FIG. 5 is a block diagram of the power-signal generating circuit board of the backlight module according to the preferred embodiment of the invention;

FIG. 6 is a schematic diagram showing the major components of the power-signal generating circuit board of FIG. 5; and

FIG. 7 is another schematic diagram showing the power-signal generating circuit board of FIG. 5.

### DETAILED DESCRIPTION OF THE INVENTION

The present invention will be apparent from the following detailed description, which proceeds with reference to the accompanying drawings, wherein the same references relate to the same elements.

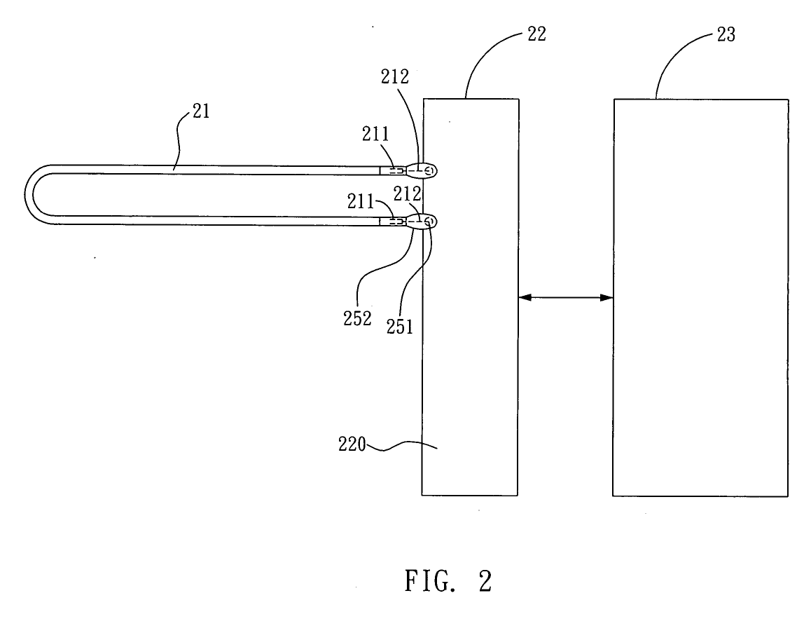

With reference to FIG. 2, a backlight module according to a preferred embodiment of the invention includes at least one light-emitting unit 21, a power-signal generating circuit board 22 and a control circuit board 23.

The light-emitting unit 21 at least has an electrode 211 and an electrode pin 212. In the embodiment, the light-emitting unit 21, which is a cold cathode fluorescent lamp (CCFL), includes two electrodes 211 and two electrode pins 212 connecting to the electrodes 211 respectively. Alternatively, the light-emitting unit can be a hot cathode fluorescent lamp or a flat lamp.

The power-signal generating circuit board 22 at least generates a power signal for driving the light-emitting unit 21. The electrode pins 212 of the light-emitting unit 21 directly connect to the power-signal generating circuit board 22. In the current embodiment, the electrode pin 212 of the light-emitting unit 21 may be welded to the power-signal generating circuit board 22 so as to form a soldering point 251. Thus, the electrode pin 212 can direct connect to the power-signal generating circuit board 22. Then, a protecting layer 252, which is high-voltage durable, is formed. Of course, the electrode pin(s) 212 of the light-emitting unit 21 may electrically connect to the power-signal generating circuit board 22 by any other method.

The control circuit board 23 electrically connects to the power-signal generating circuit board 22. In general, the control circuit board 23 electrically connects to the power-signal generating circuit board 22 with a connecting wire (not shown). The control circuit board 23 at least generates a switching signal, and the power-signal generating circuit board 22 generates the power signal according to the switching signal. In the embodiment, the operation voltage of the control circuit board is less than 250 volts.

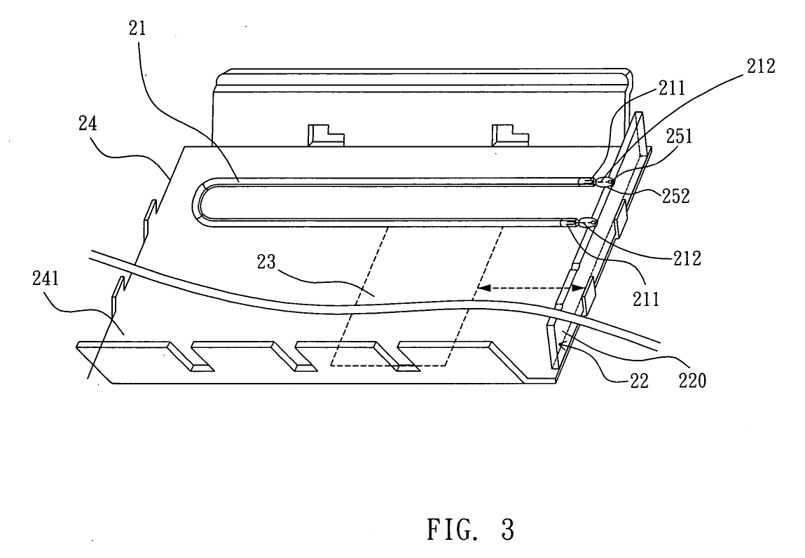

With reference to FIG. 3, the backlight module according to the embodiment of the invention further includes a case 24. In this embodiment, the case 24, which is a metal case, has a reflecting surface 241. The light-emitting unit 21 and the power-signal generating circuit board 22 are located adjacent to the reflecting surface 241 and installed on the case 24. As shown in FIG. 3, the power-signal generating circuit board 22 at least has a circuit surface 220, and the circuit surface 220 is substantially perpendicular to the reflecting surface 241. Certainly, with regarding to the case design and the application, the circuit surface 220 may be substantially parallel to the reflecting surface 241 (as shown in FIG. 2). To be noted, since the power-signal generating circuit board 22 is located adjacent to the reflecting surface 241 of the case 24 and is shielded by the metal case 24, the EMI phenomenon caused by the high voltage of the power-signal generating circuit board 22 can be efficiently prevented. In addition, the operation voltage of the control circuit board 23 is lower, so that the control circuit board 23 can be placed at another side of the case 24 opposite to the reflecting surface 241 as shown in FIG. 3.

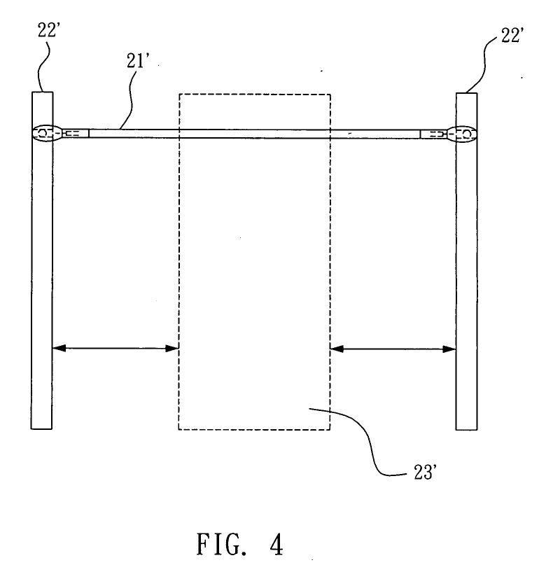

As mentioned above, the light-emitting unit 21 is a U-shaped CCFL as shown in FIG. 3. With reference to FIG. 4, the light-emitting unit 21′ is a straight shaped CCFL, which needs two driving units. Two power-signal generating circuit boards 22′ for driving light-emitting unit 21′ are respectively disposed at two ends of the light-emitting unit 21′.

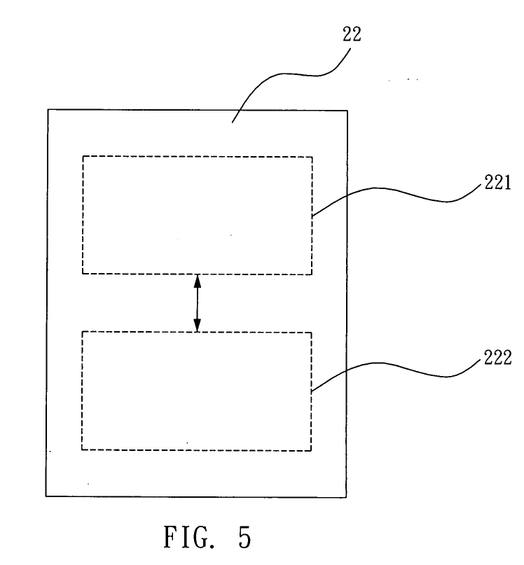

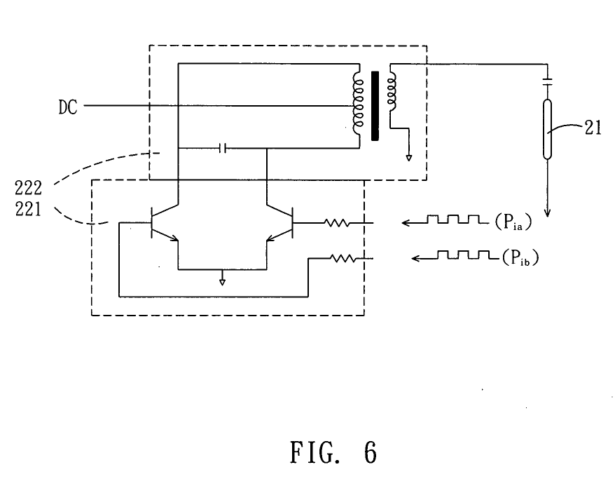

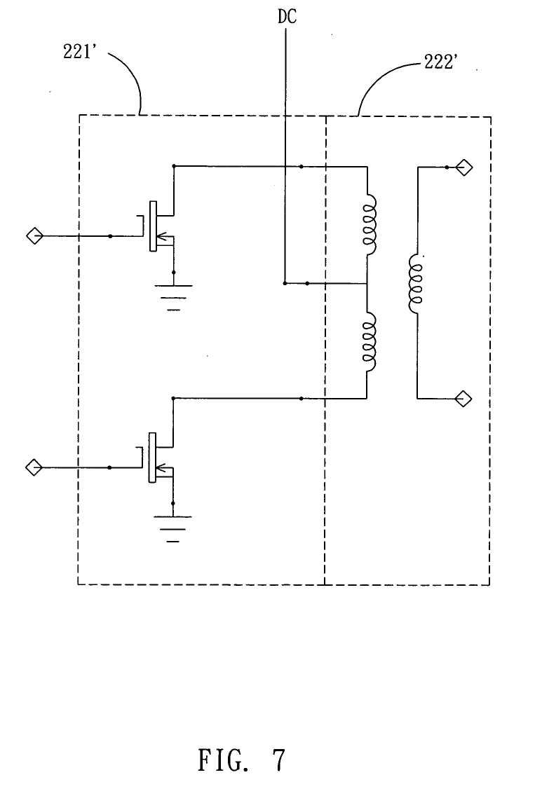

As mentioned above, the power-signal generating circuit board 22 (22′) includes a switching circuit 221 and a step-up circuit 222 as shown in FIG. 5. The switching circuit 221 electrically connects to the control circuit board 23 and is turned on/off according to a set of switching signals Pᵢₐ and P_{ib} outputted by the control circuit board 23 (as shown in FIG. 6). The step-up circuit 222 electrically connects to the switching circuit 221 and generates the power signal depending on an on/off state of the switching circuit 221. FIG. 6 is a schematic diagram showing the specific components of the power-signal generating circuit board 22. Referring to FIG. 6, the step-up circuit 222 of the power-signal generating circuit board 22 includes a transformer and a capacitor, and the switching circuit 221 includes two transistors. The transistors are respectively connected to two ends of the capacitor, and are turned on/off depending on the switching signal. With reference to FIG. 7, the power-signal generating circuit board may have different configuration. In this case, the step-up circuit 222′ includes a transformer, and the switching circuit 221′ includes two transistors. The transistors are connected to the secondary coil of the transformer, and are turned on/off depending on the switching signal.

In brief, the light-emitting unit of the backlight module directly connects to the power-signal generating circuit board. In other words, the high-voltage driving signal provided by the power-signal generating circuit board is directly inputted into the light-emitting unit. Besides, the electrical transmission signal between the power-signal generating circuit board and the control circuit board belongs to the lower voltage level. Thus, the arcing phenomenon caused by the high voltage can be prevented. Furthermore, since the light-emitting unit directly connects to the power-signal generating circuit board, the conventional connecting wire is unnecessary. That is, the assembling process of the light-emitting unit and the power-signal generating circuit board can be performed by utilizing an automatic machine without any more labor work. Moreover, the light-emitting unit and the power-signal generating circuit board are directly connected, so that the high-voltage durable connecting wire and connecting terminals are unnecessary. In other words, the cost for the expensive high-voltage durable connecting wire and connecting terminals can be saved, and, of course, the current leakage phenomenon can be prevented.

The descriptions hereinabove are to illustrate the backlight module according to the preferred embodiment of the invention.

The liquid-crystal display apparatus of the invention will be described hereinafter.

The liquid-crystal display apparatus according to a preferred embodiment of the invention mainly includes a liquid-crystal display unit and a backlight module. Herein, the features of the backlight module of the liquid-crystal display apparatus are the same as those of the previously mentioned backlight module in the above embodiment, so the detailed descriptions are omitted for concise purpose.

In this embodiment, the backlight module of the liquid-crystal display apparatus includes at least one light emitting unit 21, a power-signal generating circuit board 22 and a control circuit board 23 (referring to FIG. 2). The light-emitting unit 21 at least has an electrode pin 212. The power-signal generating circuit board 22 at least generates a power signal for driving the light-emitting unit 21. The electrode pin 212 of the light-emitting unit 21 directly connects to the power-signal generating circuit board 22. The control circuit board 23 electrically connects to the power-signal generating circuit board 22 and at least generates a set of switching signals. The power-signal generating circuit board 22 generates the power signal according to the set of switching signals.

In summary, in the backlight module of the liquid-crystal display apparatus of the invention, the light-emitting unit directly connects to the power-signal generating circuit board. In other words, the high-voltage driving signal provided by the power-signal generating circuit board is directly inputted into the light-emitting unit. Besides, the electrical transmission signal between the power-signal generating circuit board and the control circuit board belongs to the lower voltage level. Thus, the arcing phenomenon caused by the high voltage can be prevented. Furthermore, since the light-emitting unit directly connects to the power-signal generating circuit board, the conventional connecting wire is unnecessary. That is, the assembling process of the light-emitting unit and the power-signal generating circuit board can be performed by utilizing an automatic machine without any labor work. Moreover, the light-emitting unit and the power-signal generating circuit board are directly connected to each other, so that the high-voltage durable connecting wire and connecting terminals are unnecessary. In other words, the cost for the expensive high-voltage durable connecting wire and connecting terminals can be saved, and, of course, the current leakage phenomenon can be prevented.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A backlight module, comprising:
at least a light-emitting unit at least having an electrode pin;
a power-signal generating circuit board at least generating a power signal for driving the light-emitting unit, wherein the electrode pin of the light-emitting unit directly connects to the power-signal generating circuit board; and
a control circuit board electrically connecting to the power-signal generating circuit board and at least generating a switching signal, wherein the power-signal generating circuit board generates the power signal according to the switching signal.

2. The backlight module of claim 1, wherein an operation voltage of the control circuit board is less than 250 volts.

3. The backlight module of claim 1, further comprising:
a case having a reflecting surface, wherein the light-emitting unit and the power-signal generating circuit board are located adjacent to the reflecting surface and installed on the case.

4. The backlight module of claim 3, wherein the case is a metal case.

5. The backlight module of claim 3, wherein the power-signal generating circuit board at least has a circuit surface, and the circuit surface is substantially parallel to the reflecting surface.

6. The backlight module of claim 3, wherein the power-signal generating circuit board at least has a circuit surface, and the circuit surface is substantially perpendicular to the reflecting surface.

7. The backlight module of claim 1, wherein the power-signal generating circuit board comprises:
a switching circuit electrically connecting to the control circuit board and turned on/off according to the switching signal outputted by the control circuit board; and
a step-up circuit electrically connecting to the switching circuit and generating the power signal depending on an on/off state of the switching circuit.

8. The backlight module of claim 1, wherein the light-emitting unit is a cold cathode fluorescent lamp (CCFL).

9. The backlight module of claim 1, wherein the light-emitting unit is a flat lamp.

10. A liquid-crystal display apparatus comprising a backlight module, the backlight module comprising:
at least a light-emitting unit at least having an electrode pin;
a power-signal generating circuit board at least generating a power signal for driving the light-emitting unit, wherein the electrode pin of the light-emitting unit directly connects to the power-signal generating circuit board; and
a control circuit board electrically connecting to the power-signal generating circuit board and at least generating a switching signal, wherein the power-signal generating circuit board generates the power signal according to the switching signal.

11. The apparatus of claim 10, wherein an operation voltage of the control circuit board is less than 250 volts.

12. The apparatus of claim 10, wherein the backlight module further comprises:
a case having a reflecting surface, wherein the light-emitting unit and the power-signal generating circuit board are located adjacent to the reflecting surface and installed on the case.

13. The apparatus of claim 12, wherein the case is a metal case.

14. The apparatus of claim 12, wherein the power-signal generating circuit board at least has a circuit surface, and the circuit surface is substantially parallel to the reflecting surface.

15. The apparatus of claim 12, wherein the power-signal generating circuit board at least has a circuit surface, and the circuit surface is substantially perpendicular to the reflecting surface.

16. The apparatus of claim 10, wherein the power-signal generating circuit board comprises:
a switching circuit electrically connecting to the control circuit board and turned on/off according to the switching signal outputted by the control circuit board; and
a step-up circuit electrically connecting to the switching circuit and generating the power signal depending on an on/off state of the switching circuit.

17. The apparatus of claim 10, wherein the light-emitting unit is a cold cathode fluorescent lamp (CCFL).

18. The apparatus of claim 10, wherein the light-emitting unit is a flat lamp.
